(19) United States
(12) Patent Application Publication
(10) Pub. No.: US 2007/0031206 A1
(43) Pub. Date: Feb. 8, 2007

(54) Target dolly apparatus

(76) Inventor: Erick E. Kreager, Newark, OH (US)

Correspondence Address: S. Michael Bender, P.O. Box 530-399, St. Petersburg, FL, 33747, US

(21) Appl. No.: 11/415,538

(22) Filed: May 2, 2006

Related U.S. Application Data
(60) Provisional application No. 60/697,929, filed on Jul. 11, 2005.

(51) Int. Cl. B62B 1/00

(52) U.S. Cl. 410/51

(57) ABSTRACT

A dolly apparatus is provided for carrying an article secured thereto and includes a base and article securing means connected to the base for securing the article to the base. The article securing means project upward from the base. With one class of embodiments of the invention, wheel assemblies are connected to the base, and a handle is connected to the base, wherein a combination of the base and the wheel assemblies comprise a carriage portion, such that the handle is connected to the carriage portion. Preferably, the article securing means are in the form of either fixed or movable article-securing rods to accommodate a variety of dimensions of three-dimensional targets. The article includes rod-reception wells for receiving the fixed or movable article-securing rods for securing the article to the carriage portion. Preferably, the article is in the form of an archery target, such as the form of a three-dimensional animal.

### BACKGROUND OF THE INVENTION

### CROSS-REFERENCE TO RELATED APPLICATION

This application claims priority based upon my copending Provisional Application Ser. No. 60/697,929, filed Jul. 11, 2005.

### FIELD OF THE INVENTION

The present invention relates generally to portable targets, and, more particularly, to portable targets that are especially adapted for use in archery practice.

### DESCRIPTION OF THE PRIOR ART

The use of portable targets for archery practice is well known in the art. In this respect, throughout the years, a number of innovations have been developed relating to portable archery targets, and the following U. S. patents are representative of some of those innovations: 4,203,600, 4,813,684, 5,465,977, 5,503,403, and 5,938,203.

More specifically, U.S. Pat. No. 4,203,600 discloses a portable three-dimensional target that has a removable score sheet. Downwardly descending ground stakes are connected to the respective feet portions of the three-dimensional target to fix and stabilize the target on the ground. The required use of the ground stakes may be problematical if the ground is especially hard, such as during freezing conditions. Moreover, attempting to force the ground stakes into hard ground can result in damage to the target. In this respect, it would be desirable if a portable archery target does not include downwardly descending ground stakes that must penetrate the ground in order to maintain the target in a fixed and stable position.

U. S. Pat. No. 4,813,684 discloses a target for bow and arrow that is supported on a wheeled dolly. The targets are supported on the dolly at a height which exceeds the height of the wheels of the dolly. As a result, the targets have a relatively high center of gravity, which is a factor contributing to the potential for a target to be knocked over by an arrow that strikes the target. Moreover, real wildlife generally stands on the ground. Since the targets are supported on the dolly at a height which exceeds the height of the wheels of the dolly, the targets supported by this dolly present an unrealistic target. In this respect, it would be desirable if a wheeled archery target were provided that supports a target at a position below the height of its dolly wheels and close to the ground.

U.S. Pat. No. 5,465,977 discloses an archery target stop. Just as with U.S. Pat. No. 4,813,684 discussed above, the target stop is supported above the ground at a height above the height of the wheels of the target stop.

U.S. Pat. No. 5,503,403 discloses three-dimensional archery targets that include downwardly descending metal pipes that fit over stakes that have been driven into the ground. Though these targets are inherently portable, the need for stakes that have been driven into the ground is quite burdensome. As stated above with respect to the discussion of U.S. Pat. No. 4,203,600, when the ground is frozen, ground penetration may be quite burdensome. Moreover, if a target is removed from the ground penetration stakes, the stakes themselves must also be removed from the ground, so as not to litter the environment and so as not to create dangerous obstacles which stick up from the ground.

U.S. Pat. No. 5,938,203 discloses a portable target stand and target. A target is supported off of the ground by the stand. Moreover, the stand has only one purpose, and that is to support the target. Rather than have a stand that serves the singular purpose of supporting a target, it would be desirable if the stand could also serve to support other archery related articles, such as arrows.

Still other features would be desirable in a target dolly apparatus. For example, different three-dimensional targets, such as shown in U.S. Pat. Nos. 4,203,600 and 5,503,403, have different dimensions. More specifically, different three-dimensional targets have different distances between feet portions of the respective targets. In this respect, it would be desirable to provide a target dolly apparatus that allows adjustments to accommodate different distances between feet portions of different three-dimensional targets.

As mentioned above, it is not desirable to leave ground penetration stakes in the ground after a three-dimensional target is removed from the ground. However, it would be desirable to provide a target dolly apparatus which optionally includes a ground penetration pin which is automatically removed from the ground when the target dolly apparatus is lifted off of the ground.

Thus, while the foregoing body of prior art indicates it to be well known to use a target dolly, the prior art described above does not teach or suggest a target dolly apparatus which has the following combination of desirable features: (1) does not include downwardly descending ground stakes that must penetrate 10 the ground in order to maintain the target in a fixed and stable position; (2) supports a target at a position below the height of its dolly wheels and close to the ground; (3) does not require the use of ground penetration stakes that create dangerous obstacles in the ground if they are not removed from the ground after the archery target is removed; (4) can also support other archery related articles, such as arrows; (5) allows adjustments to accommodate different distances between feet portions of different three-dimensional targets; and (6) includes a ground penetration pin which is automatically removed from the ground when the target dolly is lifted off of the ground. The foregoing desired characteristics are provided by the unique target dolly apparatus of the present invention as 20 will be made apparent from the following description thereof. Other advantages of the present invention over the prior art also will be rendered evident.

### SUMMARY OF THE INVENTION

To achieve the foregoing and other advantages, the present invention, briefly described, provides a dolly apparatus for carrying an article secured thereto and includes a base and article securing means connected to the base for securing the article to the base. The article securing means project upward from the base. With one class of embodiments of the invention, wheel assemblies are connected to the base, and a handle is connected to the base, wherein a combination of the base and the wheel assemblies comprise a carriage portion, such that the handle is connected to the carriage portion, and the article securing means are connected to the carriage portion for securing the article to the carriage portion.

Preferably, the article securing means are in the form of fixed article-securing rods, and the article includes rod-reception wells for receiving the fixed article-securing rods for securing the article to the carriage portion. Preferably, the article is in the form of an archery target. Preferably, the archery target is in the form of a three-dimensional animal.

Preferably, the carriage portion includes a planar carriage frame, and wheel assemblies are connected to the carriage frame. A handle-reception socket is connected to the carriage frame for receiving the handle. Handle-locking bolts are connected to the handle-reception socket for locking the handle in the handle-reception socket.

In accordance with another aspect of the invention, rod holder supports are connected to the base. A movable rod holder is supported by the rod holder support. A movable article-securing rod is connected to the movable rod holder. Holder-to-support locking means are connected to the movable rod holder, for locking the movable rod holder to a selected position along the rod holder supports.

In accordance with another aspect of the invention, a portable target support apparatus is provided for carrying an article secured thereto and includes a base. Article securing means are connected to the base for securing the article to the base. The article securing means project upward from the base. A utility rack is connected to the base and projecting upward therefrom, and containers are connected to the utility rack.

In addition, article-holder brackets are connected to the utility rack. Rack-reception sockets are connected to the base between the base and the utility rack. The rack-reception sockets for receiving the utility rack.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least six preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved target dolly apparatus which has all of the advantages of the prior art and none of the disadvantages.

It is another object of the present invention to provide a new and improved target dolly apparatus which may be easily and efficiently manufactured and marketed.

It is a further object of the present invention to provide a new and improved target dolly apparatus which is of durable and reliable construction.

An even further object of the present invention is to provide a new and improved target dolly apparatus which is susceptible of a low cost of manufacture with regard to both materials and labor, and which accordingly is then susceptible of low prices of sale to the consuming public, thereby making such target dolly apparatus available to the buying public.

Still yet a further object of the present invention is to provide a new and improved target dolly apparatus which does not include downwardly descending ground stakes that must penetrate the ground in order to maintain the target in a fixed and stable position.

Still another object of the present invention is to provide a new and improved target dolly apparatus that supports a target at a position below the height of its dolly wheels and close to the ground.

Yet another object of the present invention is to provide a new and improved target dolly apparatus which does not require the use of ground penetration stakes that create dangerous obstacles in the ground if they are not removed from the ground after the archery target is removed.

Even another object of the present invention is to provide a new and improved target dolly apparatus that can also support other archery related articles, such as arrows.

Still a further object of the present invention is to provide a new and improved target dolly apparatus which allows adjustments to accommodate different distances between feet portions of different three-dimensional targets.

Yet another object of the present invention is to provide a new and improved target dolly apparatus that includes a ground penetration pin which is automatically removed from the ground when the target dolly is lifted off of the ground.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a first embodiment of the target dolly apparatus of the invention, wherein an archery target is in the form of a deer target.

FIG. 2 is a rear view of the embodiment of the target dolly apparatus shown in FIG. 1 taken along line 2-2 of FIG. 1.

FIG. 3 is a partially exploded side view of the embodiment of the target dolly apparatus of FIG. 1, wherein an archery target is in the form of a bear target.

FIG. 4 is a front view of the embodiment of the invention shown in FIG. 3 taken along line 4-4 thereof.

FIG. 5 is a partially exploded top view of the embodiment of the invention shown in FIG. 3, taken along line 5-5 thereof.

FIG. 6 is a side view of a second embodiment of the invention which includes a utility rack connected to the apparatus of the invention, wherein the utility rack is oriented from front to back of the apparatus.

FIG. 7 is a side view of a third embodiment of the invention which includes a utility rack that is oriented from side to side of the apparatus.

FIG. 8 is a rear view of the embodiment of the invention shown in FIG. 7.

FIG. 9 is a rear view of a third embodiment of the invention wherein the utility rack of the invention is supported by an independent utility rack base.

FIG. 10 is a top view of the embodiment of the invention shown in FIG. 9, taken along line 10-10 thereof.

FIG. 11 is a top view of a fourth embodiment of the invention which includes a movable rod holder and a movable article-securing rod supported thereon.

FIG. 12 is a side view of the embodiment of the invention shown in FIG. 11, taken along line 12-12 thereof, wherein a three-dimensional target in the form of a standing bear is supported by this embodiment of the invention.

FIG. 13 is an enlarged cross-sectional view of the portion of the embodiment of the invention shown in FIG. 11, taken along line 13-13 thereof.

FIG. 14 is a top view of a fifth embodiment of the invention which includes two movable rod holders.

FIG. 15 is a top view of a sixth embodiment of the invention which includes two movable rod holders.

FIG. 16 is an enlarged cross-sectional view of the portion of the embodiment of the invention shown in FIG. 15, taken along line 16-16 thereof.

### DESCRIPTION OF THE PREFERRED EMBODIMENT

With reference to the drawings, a new and improved target dolly apparatus embodying the principles and concepts of the present invention will be described.

Turning to FIGS. 1-4, there is shown a first embodiment of the target dolly apparatus of the invention generally designated by reference numeral 10. This dolly apparatus 10 is provided for carrying an article secured thereto and includes a base 50 and article securing means connected to the base 50 for securing the article to the base 50. The article securing means project upward from the base 50. With one class of embodiments of the invention, wheel assemblies 26 are connected to the base 50, and a handle 14 is connected to the base 50 preferably at an upwardly extending angle thereto as substantially depicted, wherein a combination of the base 50 and the wheel assemblies 26 comprise a carriage portion, such that the handle 14 is connected to the carriage portion, and the article securing means are connected to the carriage portion for securing the article to the carriage portion.

In the first embodiment, a dolly apparatus 10 is provided for carrying an article secured thereto and includes a carriage portion, a handle 14 connected to the carriage portion, and article securing means connected to the carriage portion for securing the article to the carriage portion. The dolly apparatus 10 provides that an article, such as a three-dimensional archery target, is held in an upright and secure position. Also, the dolly apparatus 10 provides complete mobility for moving the article, e. g. the archery target, and putting the article away. The article securing means can be in the form of fixed article-securing rods or members 18, and the article includes rod-reception wells 22 that are provided for receivingly engaging the fixed article-securing rods 18 for securing the article to the carriage portion.

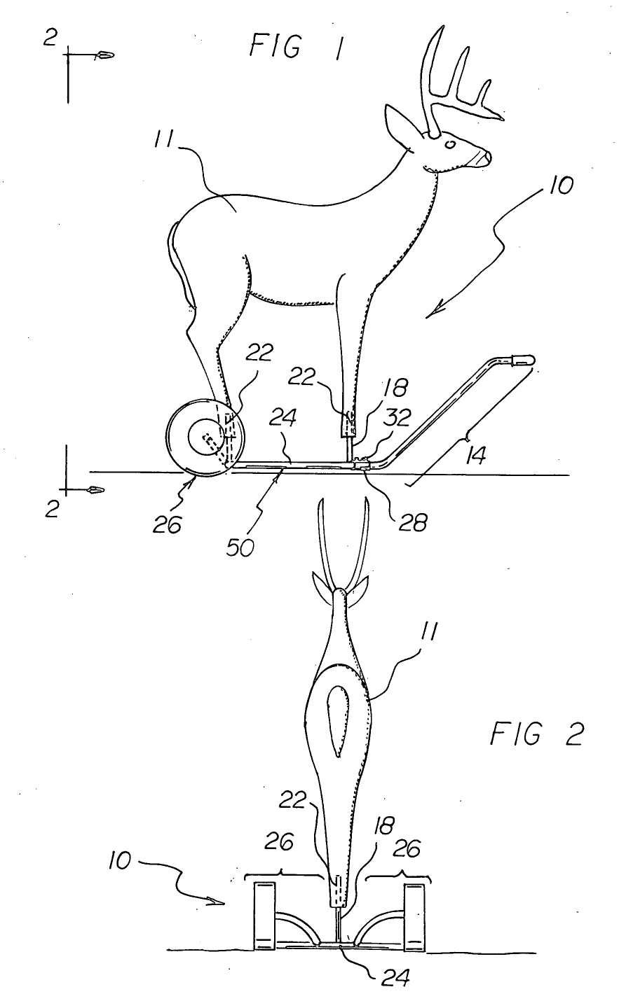

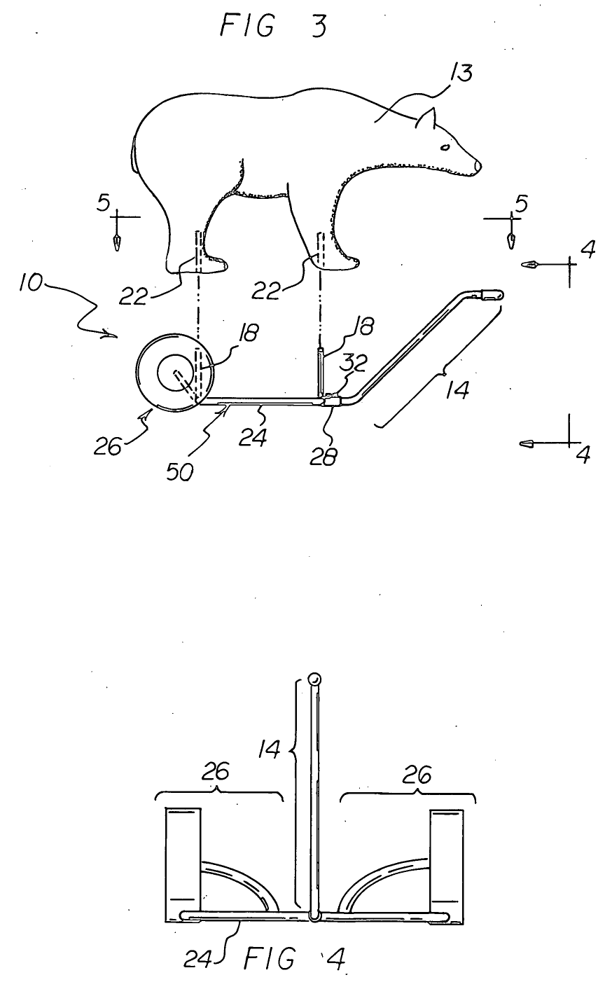

Preferably, the archery target is in the form of a three-dimensional animal. More specifically, the archery target can be in the form of a three-dimensional deer target 11, as shown in FIGS. 1-2. Also, the archery target can be in the form of a three-dimensional bear target 13, as shown in FIG. 3.

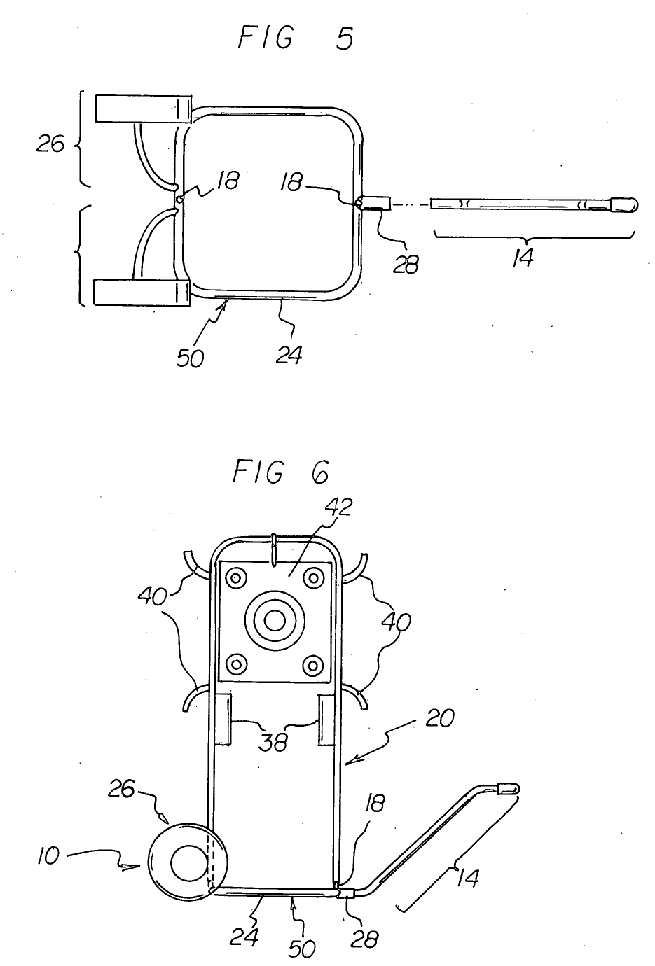

Preferably, the carriage portion includes a planar carriage frame 24, and wheel assemblies 26 are connected to the carriage frame 24. The wheel assembliues 26 preferably are attached to the carriage frame 24 by upwardly extending axles respectively such that the carriage frame is supported thereon in a position generally parallel to and proximal to the ground upon which the wheels assemblies repose. That is by virtue of the upwardly extending axles connecting the wheel assmblies to the carriage frame, the carriage frame is supported substantially below the rotational center of each wheel assembly and proximal to the ground plane when the carriage frame is positioned in a static or non-moving state on the ground of other surface substantially as shown in FIGS. 1 and 2. By this unique arrangement, the carriage frame provides an extremely stable platform when in the rest or non-moving position or condition. Preferably, a handle-reception socket 28 is connected to the carriage frame 24 for receiving the handle 14. As shown in FIG. 5, the handle 14 can be secured to the carriage frame 24 using the handle-reception socket 28. Handle-locking bolts 32 are connected to the handle-reception socket 28 for locking the handle 14 in the handle-reception socket 28.

Turning to additional embodiments of the invention, reference numerals are shown that correspond to like reference numerals that designate like elements shown in the other figures.

In accordance with another aspect of the invention, a utility rack 20 can be connected to the carriage portion. As shown in FIG. 6, the utility rack 20 can be connected to the fixed article-securing rods 18 attached to the carriage portion for securing the utility rack 20 onto the carriage portion.

Containers 38 can be connected to the utility rack 20. Also, article-holder brackets 40 can be connected to the utility rack 20. Also, rack-reception sockets 36 can be connected to the carriage portion between the carriage frame 24 and the utility rack 20.

As shown in FIG. 8, the containers 38 can be used for containing arrows 15. The article-holder brackets 40 can be used for retaining archery bows (not shown). In addition, as shown in FIG. 6, the utility rack 20 can be used for supporting a two-dimensional archery target 42.

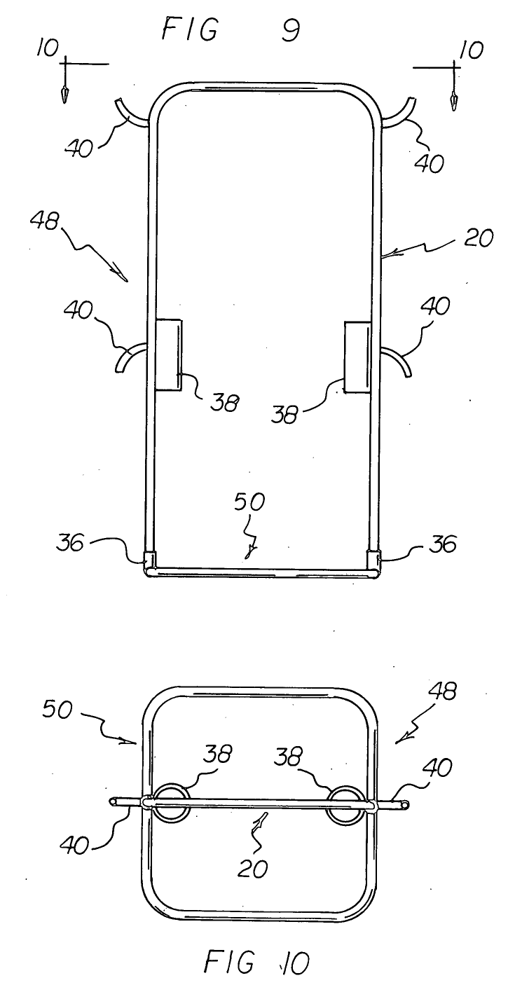

As shown in FIGS. 9-10, utility rack base 50 can be provided for connection with the utility rack 20. The utility rack base 50 includes rack-reception sockets 36 for receiving the utility rack 20.

To use the embodiment of the invention shown in FIGS. 1-5, the article, such as a deer target 11 or a bear target 13, is lowered onto the carriage portion. More specifically, the article is lowered onto the carriage frame 24 so that the fixed article-securing rods 18 are received in the rod-reception wells 22. Once the fixed article-securing rods 18 are in the rod-reception wells 22, the article is supported by the dolly apparatus 10, and the dolly apparatus 10 can be moved around by a user grasping the handle 14 and lifting the weight of the dolly apparatus 10 onto the wheel assemblies 26. Once the weight of the dolly apparatus 10 is supported by the wheel assemblies 26, the dolly apparatus 10 can be rolled along the ground by the user pulling on the handle 14.

If desired, for purposes of disassembly and storage, the handle 14 can be disconnected from the handle-reception socket 28, as shown in FIG. 5.

Instead of carrying a deer target 11, the dolly apparatus 10 can be used to carry a utility rack 20, such as shown in FIG. 6. The utility rack 20 is connected to the carriage portion by using the fixed article-securing rods 18 which project upward from the carriage frame 24.

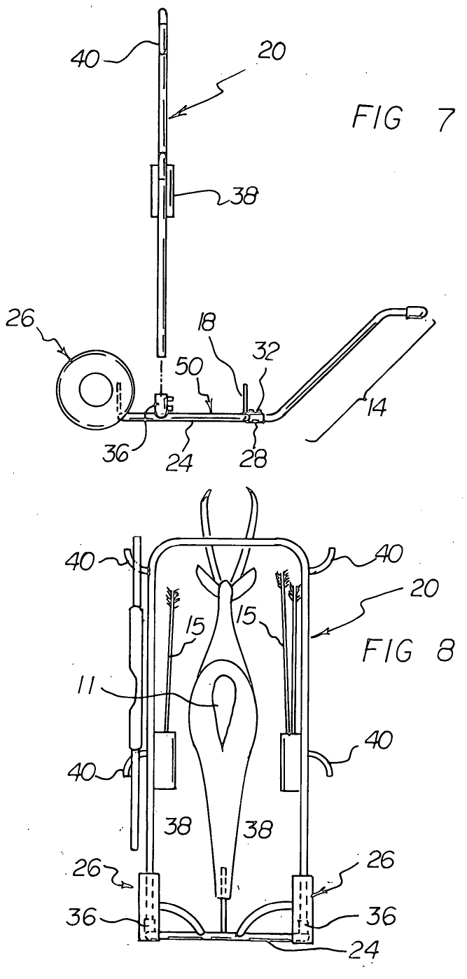

Instead of carrying the utility rack 20 by using the fixed article-securing rods 18, alternatively, as shown in FIGS. 7-8, rack-reception sockets 36 are provided on the carriage frame 24, and the utility rack 20 is received in the rack-reception sockets 36. When this is done, the utility rack 20 is secured to the carriage portion by the rack-reception sockets 36, and the deer target 11 is secured to the carriage portion by the fixed article-securing rods 18, as shown in FIG. 8.

As shown in FIGS. 9-10, the utility rack 20 can be supported by a utility rack base 50. More specifically, the utility rack base 50 has rack-reception sockets 36 for receiving the utility rack 20 and securing the utility rack 20 to the utility rack base 50. When the utility rack 20 is supported by the utility rack base 50, the dolly apparatus 10 can be used for supporting a deer target 11 or other target.

The respective sizes of the respective parts of the dolly apparatus 10, the utility rack 20, and the utility rack base 50 can be selected by keeping in mind the respective sizes and weights of the respective articles that are to be carried and supported by the respective elements.

The carriage frame 24, the utility rack 20, and the utility rack base 50 can be made from tubing materials, such as plastic or metal tubing.

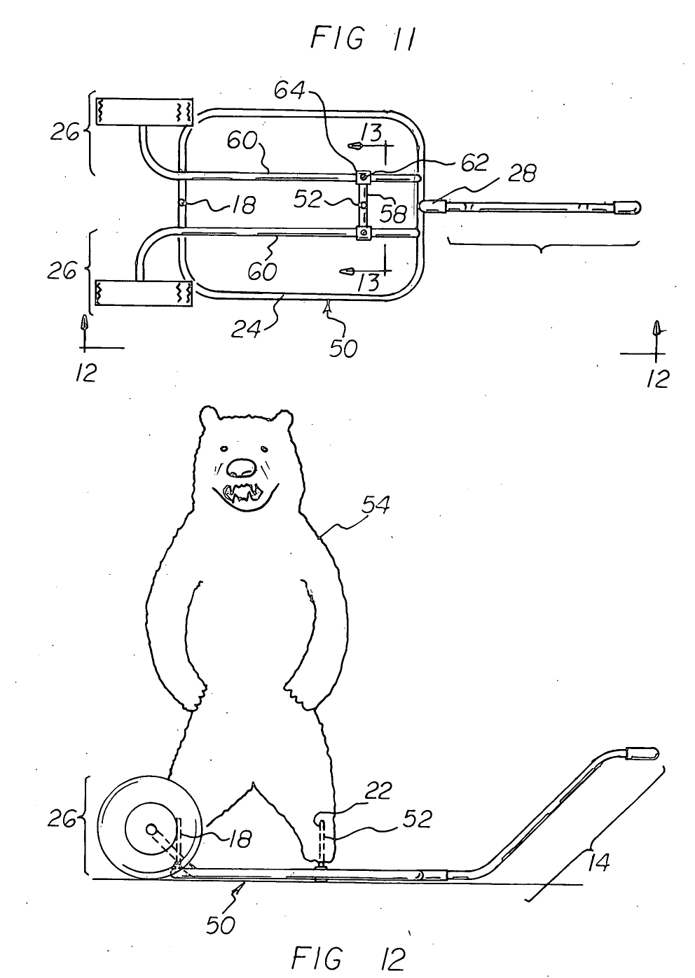

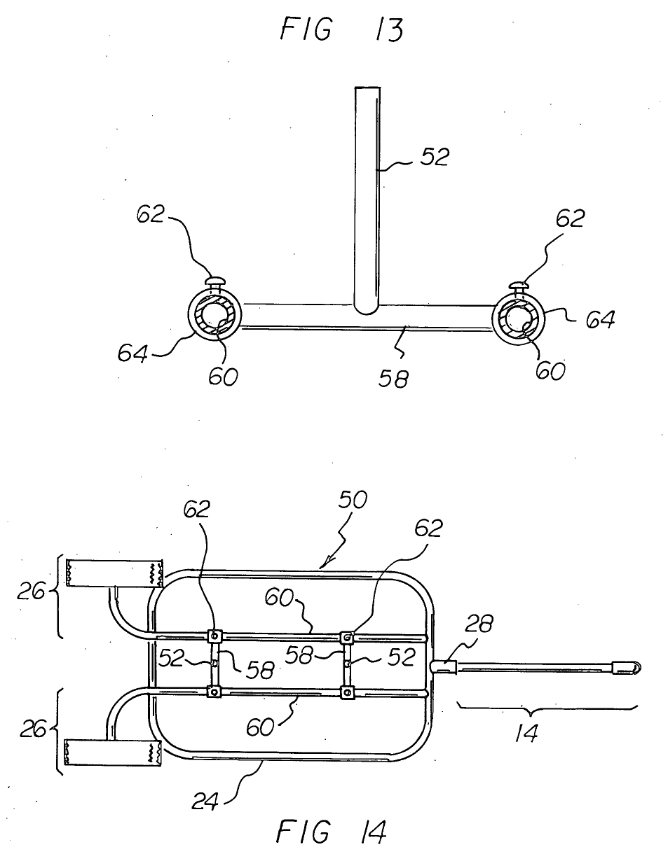

As shown in FIGS. 11-13, another embodiment of a target dolly apparatus is provided which includes a base 50, wheel assemblies 26, and a handle 14. In addition, rod holder supports 60 are connected to the base 50. A movable rod holder 58 is supported by the rod holder support 60. A movable article-securing rod 52 is connected to the movable rod holder 58. Holder-to-support locking means are connected to the movable rod holder 58, for locking the movable rod holder 58 to a selected position along the rod holder supports 60.

As shown in FIG. 12, one foot of the three-dimensional target in the form of a standing bear 54 has one foot portion in engagement with the fixed article-securing rods 18 and has another foot portion in engagement with the movable article-securing rod 52. More specifically, the holder-to-support locking means can be in the form of locking screws 62. The locking screws 62 are externally threaded and engage complementary internally threaded channels in end sleeves 64 of the movable rod holder 58. The end sleeves 64 fit circumferentially around the rod holder supports 60.

More specifically, in operation, the locking screws 62 are loosened, and the movable rod holder 58 is slid along the rod holder supports 60 so that the fixed article-securing rod 18 and the movable article-securing rod 52 are in registration with complementary rod-reception wells 22 in the feet portions of the standing bear 54.

As shown in FIG. 14, another embodiment of a target dolly apparatus is provided which includes a base 50, wheel assemblies 26, and a handle 14. In addition, a pair of movable rod holders 58 are supported on the rod holder supports 60. Each movable rod holder 58 is independently adjustable longitudinnaly along the axis defined by each of the rod holder supports 60. Loosening of the locking screws 62 on each movable rod holder 58 allows each movable rod holder 58 to be adjusted longitudinally and axially along the rod holder supports 60. Then, after the movable rod holders 58 have been adjusted, the locking screws 62 are tightened to secure the movable rod holders 58 to the rod holder supports 60 in a slecetd desired position.

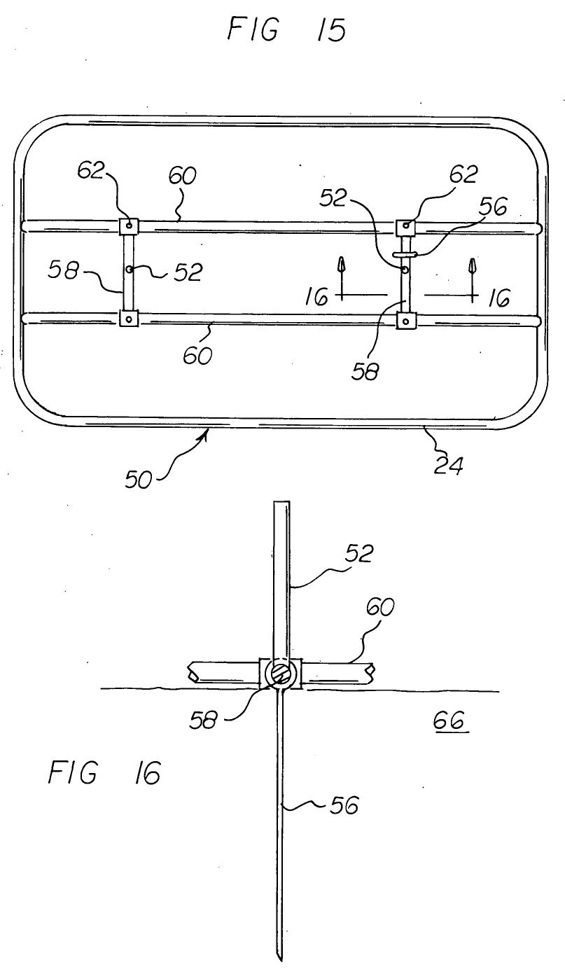

FIGS. 15-16 show another embodiment of the invention. In this embodiment, no wheel assemblies 26 and no handle 14 are provided. However, the base 50 includes a pair of rod holder supports 60 to which a pair of adjustable and movable rod holders 58 are attached. Loosening of the locking screws 62 on each movable rod holder 58 allows each movable rod holder 58 to be adjusted along the rod holder supports 60. Then, after the movable rod holders 58 have been adjusted, the locking screws 62 are tightened to secure the movable rod holders 58 to the rod holder supports 60.

In addition, an optional ground penetration pin 56 is secured to one of the movable rod holders 58. Since the ground penetration pin 56 is secured to the movable rod holder 58, when this embodiment of the invention is lifted off of the ground 66, the ground penetration pin 56 is pulled out from the ground 66, leaving no ground penetrating devices in the ground 66. If it is desired not to penetrate the pin 56 into the ground 66, the pin 56 is placed in upward oriented position (not shown) when the base 50 is placed on the ground 66.

Generally, the components of the target dolly apparatus of the invention can be made from inexpensive and durable metal and plastic materials.

As to the manner of usage and operation of the instant invention, the same is apparent from. the above disclosure, and accordingly, no further discussion relative to the manner of usage and operation need be provided.

It is apparent from the above that the present invention accomplishes all of the objects set forth by providing a new and improved target dolly apparatus that is low in cost, relatively simple in design and operation, and which may advantageously be used without employing downwardly descending ground stakes that must penetrate the ground in order to maintain the target in a fixed and stable position. With the invention, a target dolly apparatus is provided which supports a target at a position below the height of its dolly wheels and close to the ground. With the invention, a target dolly apparatus is provided which does not require the use of ground penetration stakes that create dangerous obstacles in the ground if they are not removed from the ground after the archery target is removed. With the invention, a target dolly apparatus is provided which can also support other archery related articles, such as arrows. With the invention, a target dolly apparatus is provided which allows adjustments to accommodate different distances between feet portions of different three-dimensional targets. With the invention, a target dolly apparatus is provided which includes a ground penetration pin which is automatically removed from the ground when the target dolly is lifted off of the ground.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A dolly apparatus for carrying an article secured thereto, comprising:
a base,
article securing members connected to said base for securing the article to said base, wherein said article securing members project upward from said base.

2. The apparatus of claim 1 wherein:
said article securing members are in the form of fixed article-securing rods, and
the article includes rod-reception wells for receiving said fixed article-securing rods for securing the article to said carriage portion.

3. The apparatus of claim 1 wherein the article is in the form of an archery target.

4. The apparatus of claim 3 wherein the archery target is in the form of a three-dimensional animal.

5. The apparatus of claim 1, further including:
wheel assemblies connected to said base, and
a handle connected to said base,
wherein a combination of said base and said wheel assemblies comprise a carriage portion, such that said handle is connected to said carriage portion, and
wherein said article securing members are connected to said carriage portion for securing the article to said carriage portion.

6. The apparatus of claim 5 wherein said carriage portion includes a planar carriage frame, wherein said wheel assemblies are connected to said carriage frame.

7. The apparatus of claim 6, further including:
a handle-reception socket connected to said carriage frame for receiving said handle.

8. The apparatus of claim 7, further including:
handle-locking bolts connected to said handle-reception socket for locking said handle in said handle-reception socket.

9. The apparatus of claim 1 wherein said article securing members connected to said base for securing the article to said base comprise at least a pair of article securing members on said base, at least one of said pair of article securing members being realtively adjustable on said base relative to said other of said pair of article securing members.

10. The apparatus of claim 9 wherein said pair of article securing members futher includes:
rod holder supports connected to said base,
at least one movable rod holder supported by at least one of said rod holder supports,
a movable article-securing rod connected to said at least one movable rod holder, and
at least one holder-to-support lock, connected to said at least one movable rod holder, for locking said at least one movable rod holder to a selected position along said rod holder supports.

11. A portable target support apparatus for carrying an article secured thereto, comprising:
a base,
article securing means connected to said base for securing the article to said base, wherein said article securing means project upward from said base,
a utility rack connected to said base and projecting upward therefrom, and
containers connected to said utility rack.

12. The apparatus of claim 11, further including:
article-holder brackets connected to said utility rack.

13. The apparatus of claim 12, further including:
rack-reception sockets connected to said base between said base and said utility rack for receiving said utility rack.

14. The apparatus of claim 6 wherein said wheel assemblies are attached to the carriage frame by upwardly extending axles respectively such that the carriage frame is supported thereon below the center of rotation of said wheel assemblies in a position generally parallel to and proximal to the ground upon which the wheel assemblies repose and when said apparatus is in a rest or non-moving condition.

15. A dolly apparatus for carrying an article secured thereto, comprising:
a base,
article securing members connected to said base for securing the article to said base, wherein said article securing members comprise a pair of movable and adjustable rod holders projecting upward from said base, a pair of rod holder supports on said base for supporting said movable and adjustable rod holders, wherein each said movable and adjustable rod holder is adapted to be adjusted along said rod holder supports on said base, and further including locking members for securing said movable rod holders to their corresponding rod holder supports in a selected adjusted position.

16. The dolly apparatus of claim 15 wherein said locking members comprise locking screws on each movable rod holder wherein said locking screws are adapted to be tightened to secure a movable rod holder to its corresponding rod holder support, respectively.

17. The apparatus of claim 15 further including a ground penetration pin secured to one of said movable and adjustable rod holders.
